(19) United States
(12) Patent Application Publication
(10) Pub. No.: US 2026/0241656 A1
(43) Pub. Date: Aug. 20, 2026

(54) MANUFACTURING METHOD OF SHOE UPPER PRINTED WITH 3D THREE- DIMENSIONAL DESIGN USING UPPER AND LOWER MOLDS

(71) Applicants: Heedae PARK, Busan (KR); SAM BU FINE CHEMICAL CO., LTD., Gimhae-si (KR)

(72) Inventor: Heedae PARK, Busan (KR)

(21) Appl. No.: 19/533,178

(22) Filed: Feb. 7, 2026

(30) Foreign Application Priority Data
Feb. 7, 2025 (KR) 10-2025-0015573
Mar. 17, 2025 (KR) 10-2025-0033953

(51) Int. Cl. B29D 35/12; B29D 35/00

(52) U.S. Cl. CPC B29D 35/126; B29C 59/02; B29D 35/0063; B29D 35/128

(57) ABSTRACT

A method is provided for manufacturing a shoe upper printed with a high-quality 3D patten using upper and lower molds, including: a mold preparation step of preparing the lower mold and upper mold respectively; attaching stoppers to the upper mold; a fabric preparation step for preparing a composite fabric composed of foam and textile; the lower mold and the upper mold with stoppers attached are aligned with a predetermined gap while interposing the composite fabric therebetween; a mold fitting step of installing the aligned upper mold with stoppers attached and lower mold on a press device; and an shoe upper forming step of pressing the aligned upper and lower molds using the press device while performing heating and cooling of the press device to form the upper shoe with a predetermined shape.

### CROSS-REFERENCES TO RELATED APPLICATION

The present application claims priority under 35 U.S.C. § 119 to Korean Patent Application No. 10-2025-0033953 filed on Mar. 17, 2025, and Korean Patent Application No. 10-2025-0015573 filed on Feb. 7, 2025, in the Korean Intellectual Property Office, the disclosures of which are incorporated herein by references in their entireties.

### TECHNICAL FIELD

The present invention relates to a method for manufacturing a shoe upper, and the apparatus thereof, with a high-quality 3 three-dimensional (3D) pattern printed thereon using an upper mold and a lower mold, and more specifically, a method for forming a composite fabric by aligning, interlocking, matching, or mating a lower mold and an upper mold, each of which has an intaglio, i.e., a recessed pattern and a relief, i.e., raised pattern formed thereon, and applying pressure and forming both sides of the composite fabric, thereby forming the border of the pattern to a level close to a right angle, and at the same time, forming an intaglio pattern in the area where the relief pattern is formed, thereby securing the lightness of the product, thereby forming a 3D structure that is differentiated from the conventional one. In addition, the pressure applied to the upper mold and the lower mold by the press machine is controlled by a stopper placed or inserted on the upper mold, enabling uniform quality in terms of product thickness, shape, and/or hardness. Furthermore, by forming multiple fixing pins on the lower mold, a high-quality 3D design printed on the shoe upper is manufactured using the upper mold and the lower mold without any gaps, i.e., mismatch, between the printed layer and patterns formed on the shoe upper.

### BACKGROUND OF THE INVENTION

Generally, shoes such as dress shoes, sneakers, and hiking boots are composed of the upper leather, which forms the exterior of the shoe; the outsole, which comes into contact with the ground; the midsole, which is installed on the upper side of the outsole; and the insole, which comes into contact with the sole of the foot. The outsole, midsole, and insole work together to protect the sole of the foot while ensuring a comfortable walking experience. In particular, the upper leather protects the instep while adding design elements to the shoe, thereby enhancing its marketability.

Accordingly, efforts to improve the quality and productivity of shoe uppers are ongoing, but since shoe uppers are mostly made of general 2D fabrics, films, synthetic leather, etc., they are manufactured through multi-step processes such as no-sewing or sewing, which makes the process complicated and difficult to produce products with the desired level of three-dimensionality.

For example, conventional methods for producing 3D-shaped uppers include repeatedly layering screen printing ink to form thickness, using liquid PU resin, using PU casting methods to create three-dimensional shapes by injecting resin into mold, or using methods that involve injecting and compression molding elastic resins such as TPU into mold. These conventional methods have limitations in terms of workability and product quality improvement due to complex process conditions, and many issues have been raised regarding their expanded application.

As a conventional art related to the above-mentioned shoe upper molding method, Korean Registered Patent No. 10-1768978 describes a first step of manufacturing a mold containing concavo-convex in the internal space; a second step of forming a coating layer containing a printing layer and polyurethane to manufacture a two-layer film transfer body; a third step of positioning the two-layer film transfer material fixed to the mold in an upward direction; a fourth step of injecting liquid or solid thermoplastic polyurethane to form a preform; a fifth step of fixing the fabric to the transfer substrate, and simultaneously pressing and heating the two-layer film transfer substrate, transfer substrate, and fabric to perform injection molding; a sixth step of processing the injection-molded two-layer film transfer substrate, the transfer substrate, and the fabric are processed to manufacture the shoe. This method has the advantage of protecting the transfer substrate and fabric transferred to the shoe fabric by manufacturing the shoe with the two-layer film with the shoe logo and design transferred attached to the fabric.

In addition, Korean Patent No. 10-1098941 discloses an upper for a shoe part formed as an integral part with the upper, which is injection-molded by injection molding synthetic resin using an injection molding machine, thereby simplifying the manufacturing process by a seamless injection molding method, and wherein the upper is spread on a lower mold of a mold, and then injection-molded using an upper mold having a predetermined shape engraved thereon, thereby forming the upper for a shoe part formed as an integral part with the upper, and a manufacturing method thereof. This molding method has the advantage of being simple to manufacture using a seamless injection molding method, resulting in high productivity and low defect rates, as well as the ability to easily form various patterns or complex patterns on the upper in an integrated manner.

As for the conventional technology related to molding devices for manufacturing shoe uppers, Korean Utility Model Registration No. 20-0244339 provides a passage for air injection inside the upper mold that moves vertically by the operation of a cylinder, and a pad with multiple holes is installed to seal the passage along the inner side. a bending device is mounted at the rear of the upper mold, with legs on both sides moving vertically to bend the bottom joint of the shoe upper, and a shoe upper molding machine is disclosed, in which a stopper is provided at the rear of the lower mold, which fixes the shoe upper and is equipped with a cooling means inside, so that the fixing plate moves forward and backward by the operation of the cylinder. This increases the cooling effect and enables the shoe upper to be molded with consistent and accurate dimensions, Additionally, the sole joint at the bottom of the shoe is formed simultaneously, reducing the overall number of processes and improving productivity.

Meanwhile, shoe uppers may feature patterns such as embossing, side stripes, side reinforcements, product or brand names, and manufacturer logos for visual appeal and product promotion. This invention uses a composite fabric made of foam and textile to improve the durability, elasticity, cushioning, and texture of the shoe upper while proposing a technology that forms the shoe upper's patterns into high-quality 3D designs instead of using the inefficient method of repeatedly layering screen printing ink to form thickness. The shoe upper produced by this invention not only has excellent visual effects but also forms a lightweight and differentiated three-dimensional structure compared to existing products.

### RELATED ART DOCUMENT

### Patent Document

(Patent Document 0001) Korean Patent Publication No. 10-1768978 (Published: Aug. 17, 2017).
(Patent Document 0002) Korean Patent Publication No. 10-1098941 (Published: Dec. 28, 2011).
(Patent Document 0003) Korean Utility Model Publication No. 20-0244339 (Published: Oct. 15, 2001).

### EMBODIMENTS

### Problems to be Solved

The purpose of this invention is to improve the quality of shoe uppers more efficiently by using a method of pressing and molding both sides of the composite fiber by combining, i.e., interlocking a lower mold and an upper mold, each of which has a concave and convex shape, thereby enabling the rapid and precise molding of complex patterns while manufacturing shoe uppers that are lighter and softer than conventional ones using upper and lower molds. This method provides a manufacturing method for shoe uppers with printed three-dimensional designs.

Another purpose of the present invention is to improve the method of controlling the pressure applied to the upper and lower molds using only the pressure of the conventional press machine, for example, GNH-P14T™ manufactured by GTM co., Ltd., so that the distance between the upper and lower molds is set by the thickness of the stopper formed on the upper mold, and the pressure applied to the upper and lower molds by the press machine is adjusted, thereby enabling the manufacture of uppers with uniform thickness, shape, and hardness. Additionally, by forming multiple fixed pins on the lower mold, the method produces high-quality uppers with no gaps between the printed layer and patterns on the uppers. This method provides a manufacturing method for high-quality 3D design printed shoe uppers using upper and lower molds.

### Means for Solving Problems

In order to achieve the above objectives, the method for manufacturing a shoe upper printed with a high-quality 3D design using the upper and lower molds proposed in this invention comprises: a mold preparation step S10 of manufacturing a lower mold 10 and an upper mold 20 according to the design of the product to be produced; a fabric preparation step S20 for preparing a composite fabric 1 composed of foam and textile; setting a gap, i.e., spacing distance, between the lower mold 10 and upper mold 20 when aligning, placing the composite fabric 1 between the lower mold 10 and the upper mold 20, and aligning the lower mold 10 and upper mold 20 each other; a mold fitting step S30 of installing or place the aligned upper and lower mold 10, 20 into a press machine; and a shoe upper forming step S40 of sequentially performing heating and cooling of the press machine to form the shoe upper into a predetermined shape.

According to a preferred embodiment of the present invention, the lower mold 10 may include a lower body 1 formed flat with a predetermined width, and a recessed portion 12 formed in the same shape as the outer shape and pattern of the composite material at a position corresponding to the outer shape and pattern of the composite fiber 1 within the plane allowed by the lower body 20, and guiding grooves 13 formed through each corner and adjacent positions within the plane of the lower body 11 to guide the overlapping position of the upper mold 20, the upper mold 20 may include an upper body 21 formed flat with a predetermined width, a raised portion 22 with multiple protrusions formed within the plane allowed by the upper body 21 corresponding to the recessed portion 12 of the lower mold 10, and a guiding pin 23 protruding at a position corresponding to the guiding grooves 13 of the lower mold 10 and inserted into the guiding grooves 13 of the lower mold 10 to guide the overlapping position with the lower mold 10.

Furthermore, looking at the flowchart in FIG. 1, the mold preparation step S10 may include a mold adjustment step S11 for sketching an outer shape of the mold to match a design, i.e., a pattern or shape, etc., of the product to be produced using a 3D design program, for example, Adobe illustrator; a body forming step S12 for processing the mold material to prepare the lower body 11 of the lower mold 10 and the upper body 21 of the upper mold 20, respectively; a computer numerical control (CNC) machining step S13 for engraving recessed portions 12 on the surface of the lower body 10 and raised portions 22 on the surface of the upper body 21 using a CNC machine; and a mold post-processing step S14 for cleaning, post-processing, and heat-treating for the lower mold 10 and upper mold 20 after the CNC machining is complete.

Furthermore, the composite fabric 1 manufactured in the fabric preparation step S20 may include: a first fabric composed of a textile with a thickness of 0.3 to 3.0 mm, as shown in FIG. 4; a second fabric composed of foam with a thickness of 1.0 to 10 mm, which is laminated on the upper surface of the first fabric; a third fabric 3 layered on the upper surface of the second fabric and composed of textile material with a thickness of 0.3 to 3.0 mm; and a printed layer coated on the upper surface of the third fabric with a thickness of 0.02 to 2.0 mm.

Additionally, the mold fitting step S30 shown in FIGS. 5-6 may include: a stopper 100 is inserted into the guiding pin 23 formed in the upper mold 20, and a gap between the upper mold 10 and the lower mold 20 is set according to a thickness of the stopper 100. According to an embodiment of the present invention, the stopper 100 further includes an opening portion 101 on one side to facilitate engagement with the guiding pin 23. For example, by widening or spreading the opening 101 of the stopper 100 to accommodate the guiding pin 23 and then restoring the opening 101 to its original position, the stopper 100 is press-fitted onto the guiding pin 23, resulting in a secure connection with the guiding pin 23, a fabric fixing step S31 in which the composite fabric 1 is placed on the recessed portion 12 of the lower mold 10 and temporarily fixed by inserting the composite fabric 1 into a plurality of protruding fixing pins 15 around the recessed portion 12; inserting stoppers 100 into the corresponding guiding pins 23 to set the gap between the upper mold 10 and the lower mold 20, and positioning the upper mold 20 on top of the lower mold 10 so that the guiding grooves 13 formed by the recessed edge of the lower mold 10 and the guiding pin 23 corresponding to the guiding grooves 13 on the edge of the upper mold 20 are aligned on the same vertical line; a mold stacking step S33 of stacking the upper mold 20 on the top of the lower mold 10 such that the recessed portion 12 of the lower mold 10 and the raised portion 22 of the upper mold 20 are aligned to induce double-sided pressing of the composite fabric 1.

Furthermore, as shown in FIG. 2, the shoe upper forming step S40 may include: a first pressing step S41 of pressing the shoe upper while heating the forming mold M through the upper die a and the lower die b of the press device; and a second pressing step S42 of supplying coolant to the upper die (a) and the lower die (b) of the pressing device P to cool the molding mold (M) while pressing and shaping the shoe upper, and maintaining the molded pattern according to aspect(s) of the present invention.

### Effects of the Invention

According to a method for manufacturing shoe uppers printed with high-quality 3D designs using the upper and lower molds of the present invention, by simply placing a composite fabric between the lower mold and the upper mold and applying pressure to the lower mold and upper mold in an up-down manner, patterns can be formed on the upper and various colors can be applied, thereby maximizing work convenience and efficiency. Additionally, this method enables the mass production of high-quality, lightweight uppers in a short amount of time.

In addition, unlike conventional methods that involved applying multiple layers of screen printing ink, by applying pressure to the lower mold and upper mold in an up-and-down manner, it is possible to precisely form engraved and raised patterns on the upper, resulting in sharp, protruding edges on the upper pattern that maximize the 3D effect. This allows for the clear application of various colors, thereby reducing the amount of screen-printing ink used and contributing to cost savings in production.

In addition, the present invention improves the method of controlling the pressure applied to the upper mold and the lower mold only by the pressure of a conventional press machine, so that the distance between the upper and lower molds is set by the thickness of the stopper inserted into the guiding pin of the upper mold in the mold combining step, thereby controlling the pressure applied to the upper mold and the lower mold in the press machine, so that the thickness, shape, and hardness of the product are uniformly molded, thereby minimizing the defect rate and manufacturing an shoe upper having excellent quality. In addition, by adjusting the thickness of the stopper while maintaining the pressure of the press machine constant, there is an effect of being able to produce the shoe upper of good quality under various molding conditions.

Furthermore, the present invention has the effect of enabling the desired upper shape to be achieved. This is accomplished by firmly securing the composite material during the molding process through the formation of multiple fixing pins on the lower mold. This ensures precise molding without misalignment or step formation between the printed layer and patterns formed on the shoe upper.

### BRIEF DESCRIPTION OF THE DRAWINGS

FIG. 1 is a process flow diagram illustrating, step by step, a method for manufacturing a shoe upper according to the present invention.

FIG. 2 is a schematic diagram illustrating a shoe upper mold according to the present invention mounted on a conventional press device.

FIG. 3 is a schematic diagram of a shoe upper mold according to the present invention.

FIG. 4 is a cross-sectional view illustrating a conventional laminated fabric.

FIG. 5 is a perspective view of a lower mold according to the present invention.

FIG. 6 is a perspective view of an upper mold according to the present invention.

FIG. 7 is a cross-sectional view of a patterned portion of a typical shoe upper.

FIG. 8 is an exemplary perspective view of a shoe upper manufactured using a molding mold according to the present invention.

FIG. 9 is a cross-sectional view illustrating the pattern formation of a shoe upper according to the present invention and the state in which the upper mold and the lower mold are joined.

FIGS. 10a and 10b are exemplary drawings comparing shoe uppers manufactured with and without a fixing pin according to the present invention.

### DETAILED EMBODIMENTS

Hereinafter, with reference to the attached drawings, a method for manufacturing a shoe upper with a high-quality 3D three-dimensional design printed thereon using an upper mold and a lower mold according to the present invention will be described. However, this is merely an example to enable a person having ordinary skill in the art to which the present invention pertains to easily practice the invention, and does not mean that the technical spirit and scope of the present invention are limited thereby.

Note that in this specification, the terms “upper mold” and “lower mold” are not limited to the term, but may be interchangeable. These terms refer to relative directions In a given axis.

The expression of the singular number in the specification includes the meaning of the plural number unless the meaning of the singular number is different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof. It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. The spirit of the invention may be expanded to its modifications, replacements or equivalents in addition to what is shown in the drawings.

The present invention relates to a method for manufacturing a shoe upper with a high-quality 3D three-dimensional design printed thereon using an upper and lower mold. By using a composite fabric composed of foam and textile, the durability, elasticity, cushioning, and material feel of the shoe upper are improved, thereby improving the inefficient method of implementing a 3D pattern by repeatedly layering existing dyeing inks to form a thickness.

Accordingly, a method according to aspect(s) of the present invention may adopt a method of pressing and forming both sides of the fabric by interlocking, matching, mating, or aligning the lower mold 10 and the upper mold 20 in which the negative and positive engravings are respectively formed, so that the border of the pattern is formed at a level close to a right angle, resulting in an excellent three-dimensional effect. In addition, since the negative pattern is simultaneously formed in the area where the positive pattern is formed, the lightness of the product can be secured, and a method for manufacturing a shoe upper with a high-quality 3D three-dimensional design printed thereon using the upper and lower molds, which maximizes convenience and efficiency of use from a structure differentiated from the conventional one, was developed.

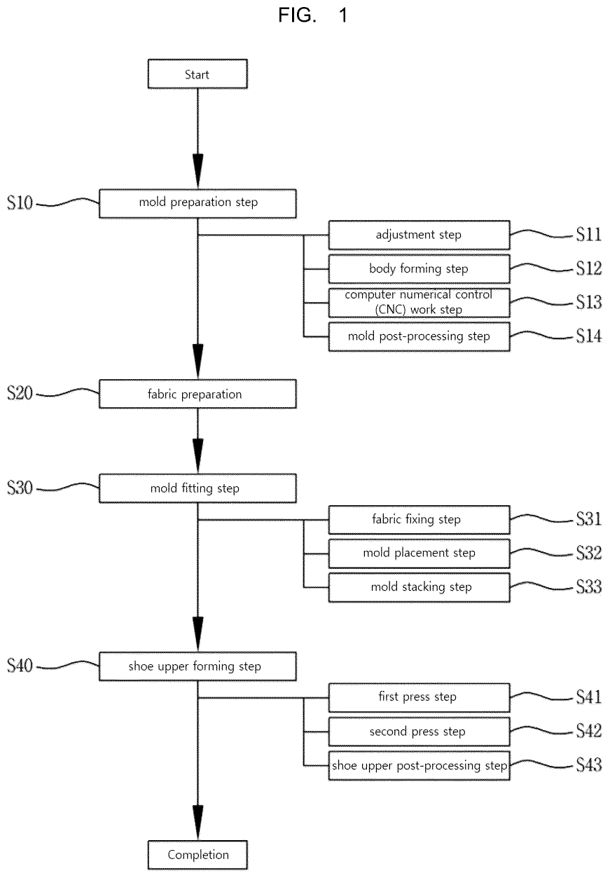

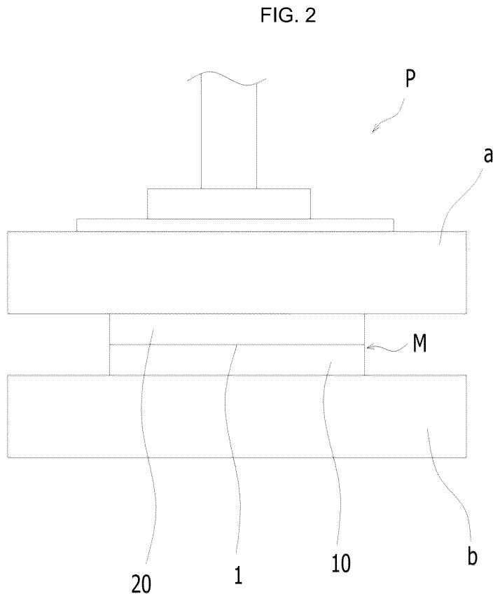

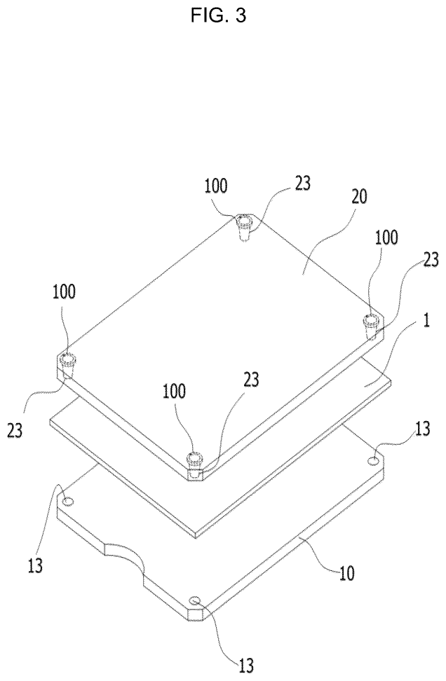

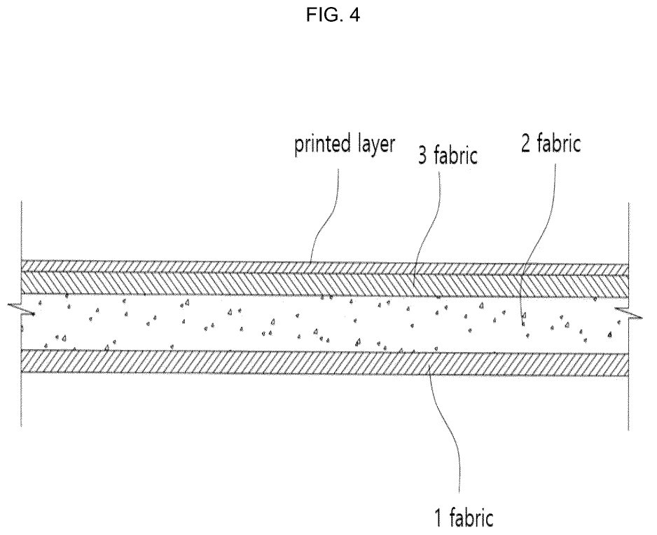

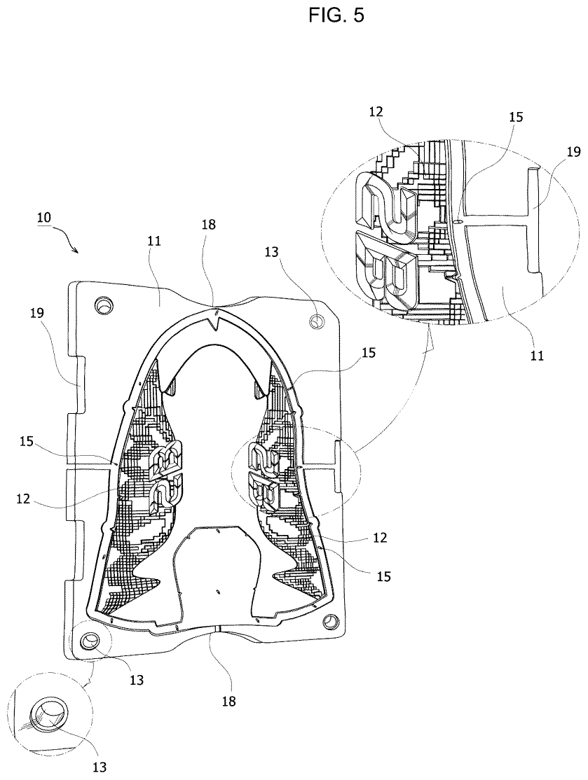

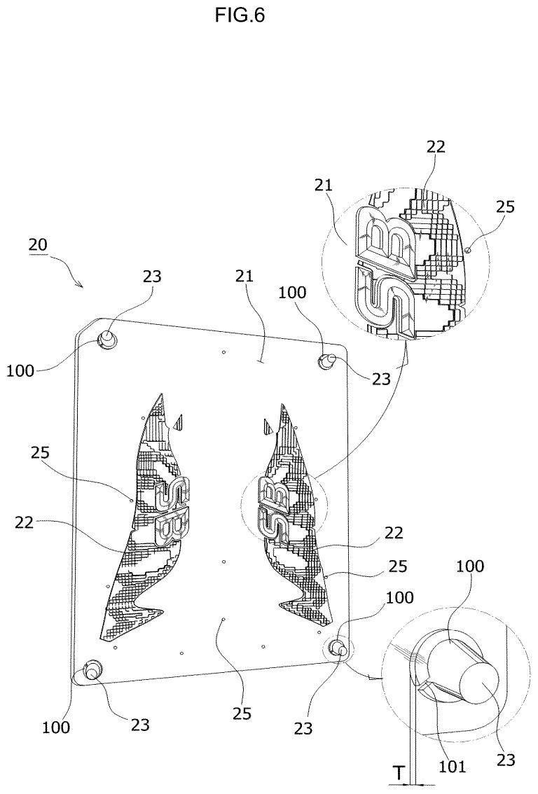

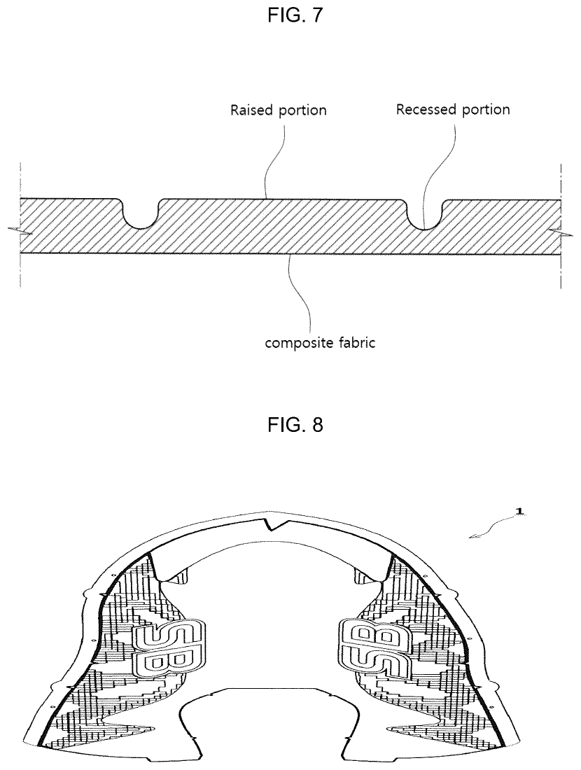

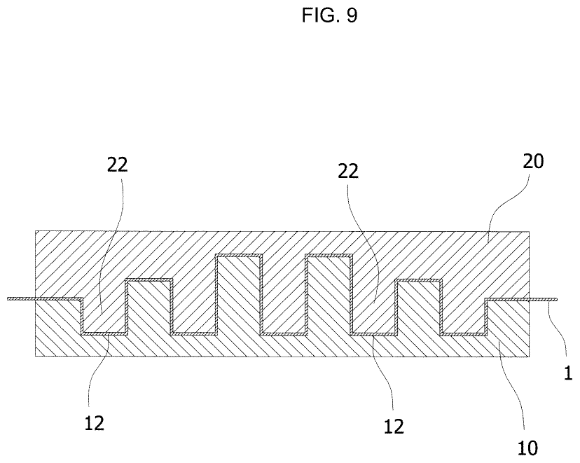

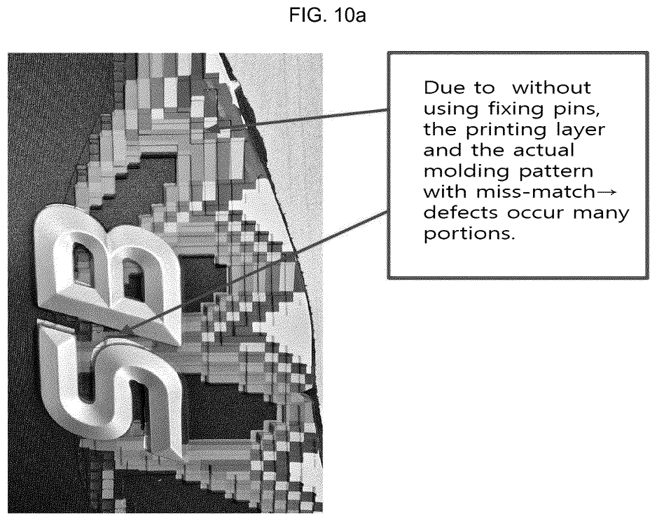

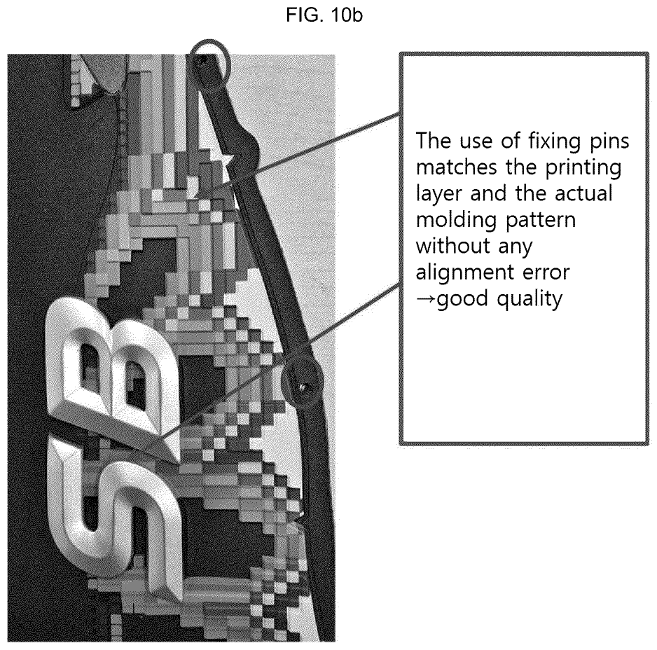

FIG. 1 is a process flow diagram showing a method for manufacturing a shoe upper according to the present invention step by step, FIG. 2 is a schematic diagram showing a state in which a shoe upper molding mold according to the present invention is mounted on a conventional press device, and FIG. 3 is a schematic diagram showing a shoe upper molding mold according to the present invention. FIG. 4 is a cross-sectional view showing a conventional synthetic fiber fabric, FIG. 5 is a perspective view showing the configuration of a lower mold according to the present invention, and FIG. 6 is a perspective view showing the configuration of an upper mold according to the present invention. FIG. 7 is a cross-sectional view showing a patterned portion in a general shoe upper, and FIG. 8 is an exemplary perspective view showing a shoe upper manufactured by a molding mold according to the present invention, and FIG. 9 is a cross-sectional view showing a form in which a pattern of a shoe upper according to the present invention is formed and a state in which an upper mold and a lower mold are combined. FIG. 10a and FIG. 10b are exemplary drawings comparing shoe uppers molded according to the non-using fixing pin according to conventional method and using fixing pin according to an aspect the present invention.

As shown in FIG. 1, the present invention relates to a method for manufacturing a shoe upper with a high-quality 3D three-dimensional design printed thereon by interlocking, matching, aligning upper and lower molds, the method may include a mold preparation step S10 of manufacturing a lower mold 10 and an upper mold 20, respectively; a fabric preparation step S20 of manufacturing a composite fabric 1; a mold fitting step S30 of installing the aligned the upper mold and the lower mold 10, 20 in a press device P; and an shoe upper forming step S40 of forming the shoe upper with a desired shape. As shown FIG. 1, the overall shape of the upper and lower molds is a cuboid, and the length, width, and height are determined by the shape of the mold but are not limited to this. The shape of the mold may very according to a shape of product to be molded.

Here, as shown in FIG. 5, the lower mold 10 may include a lower body 10 formed flat with a predetermined width, an engraved, i.e., recessed portion 12 formed in the same shape at a position corresponding to the outer shape and pattern of the composite fabric 1 within the plane allowed by the lower body 10, and a guiding grooves 13 formed through the lower body 10 at a position adjacent to a corner within the plane to guide the overlapping position of the upper mold 20. As shown in FIG. 6, the upper mold 20 may include an upper body 21 formed flat with a predetermined width a raised portion 22 having a number of protrusions formed corresponding to the recessed portion 12 of the lower mold 10 within a plane permitted by the upper body 21, and a guiding pin 23 formed protruding at a position corresponding to the guiding grooves 13 of the lower mold 10 and fitted into the guiding grooves 13 of the lower mold 10 to guide the overlapping position with the lower mold 10.

As shown in FIG. 1, first, the mold preparation step S10 is a process for manufacturing the lower mold 10 and upper mold 20 according to a design of the product, i.e., a shape of a shoe upper, to be produced. The mold preparation step may include the mold adjustment step S11; the body molding step S12; the CNC machining step S13; and mold post-processing step S14.

The mold adjustment step S11 involves sketching the mold's external shape to match the product design using 3D design software. This entails designing the shoe upper or creating a 3 three-dimensional (D) molding mold based on the shoe upper design.

As described above, in the mold adjustment stage S11, a design for the shoe upper is made, and a molding mold can be created in 3D based on this design.

The body molding step S12 is the process of processing the mold material to prepare the lower body 11 of the lower mold 10 and the upper body (21) of the upper mold (20), respectively.

As described above, in the body forming stage S12, a mold material selected from metals such as aluminum or epoxy resin is processed into a flat plate of a set thickness, and then the mold material is placed on a milling or a CNC shelf.

The above CNC processing step S13 is a process of engraving a recessed portion 12 on the surface of the lower body 10 and engraving a raised portion 22 on the surface of the upper body 21 using the CNC machine. The above CNC processing step S13 may engrave the pattern of the shoe upper placed on a shelf of the CNC machine using the 3D mold data created in the mold adjustment step S11.

As described above, in the CNC machining step S13, the 3D mold data is used to machine a recessed portion, i.e., intaglio portion, 12 in the lower mold 10 and a raised portion, i.e., an embossed portion, 22 in the upper mold 20.

The mold post-processing step S14 may include cleaning, post-processing, and heat treating the lower mold 10 and upper mold 20 after CNC machining is complete.

Meanwhile, in the mold post-processing step S14, surface treatments such as matte, semi-gloss, and gloss finishes may be performed on the lower mold 10 and upper mold 20 during the post-processing process, and release coatings such as Teflon coating may also be applied to improve the release properties from the shoe upper during demolding of the lower mold 10 and the upper mold 20 during demolding.

As described above, the molding mold of the present invention is composed of a lower mold 10 and an upper mold 20 as shown in FIGS. 5 and 6, and the lower mold 10 comprises a lower body 11 formed flat with a predetermined width, and a recessed portion 12 formed with a plurality of grooves having a predetermined shape corresponding to the pattern of the shoe upper manufactured within the plane allowed by the lower body 11.

The lower body (11) is formed into a rectangular, square, or other shape with a predetermined thickness, and is configured with sufficient width to accommodate the composite fabric 1 for the shoe upper. The lower body 11 is preferably configured such that both the upper and lower surfaces are flat, enabling it to be securely mounted on the press device (P) as shown in FIG. 2 while also facilitating the accommodation of the composite fabric 1. However, the shape of the lower body is not limited thereto.

The above-mentioned recessed portion, i.e., engraved portion 12 is formed by a plurality of grooves arranged within the range allowed by the upper surface of the lower body 11, and the form in which the grooves are arranged refers to the patterns, designs, brand names, logos, etc., formed on the shoe upper, and it refers to the main pattern formed in the shape of U as shown in FIG. 8 on both side of the foot, toes, and instep area, or the upper edge, ankle pattern, shoelace hole pattern, etc. formed with a predetermined width along the edge of the main pattern.

The upper edge and ankle area have a plurality of multiple fixed pins 15 protruding at a predetermined positions and intervals, as shown in FIG. 5, to secure the composite fabric 1 attached to the lower body 11 in place. The plurality of fixed pins 15 are cone-shaped to support the composite fabric 1 during the molding process, thereby promoting stable product productivity.

The lower mold 10 may further have a plurality of guiding grooves 13 formed on a the lower mold 10 as shown in FIG. 5. The guiding grooves 13 are formed at positions adjacent to each corner of the lower mold 10 and may be formed as recesses with a predetermined depth or as through holes penetrating the upper and lower surfaces. These guiding grooves 13 guide the guiding pins 23 of the upper mold 20 to induce their engagement, thereby guiding the stacking position to allow the upper mold 20 to be stacked precisely on the lower mold 10. Therefore, the guiding grooves 13 and guiding pins 23 are formed with corresponding diameters.

On both sides of the lower mold 10, an arched recessed inner portion 18 is formed, and when the processing of the composite fabric 1 is completed with the upper mold 20 stacked on the lower mold 10, the worker can easily separate the upper mold 20 from the lower mold 10 by holding only the upper mold 20 through the recessed inner portion 18.

In addition, a plurality of support members 19 formed as straight grooves are formed on the outer edge of the lower mold 10, wherein the support members 19 serve to separate the upper mold 20 from the lower mold 10 by inserting a lever at the position where the support members 19 are formed when the lower mold 10 and the upper mold 20 are overlapped, thereby guiding the movement of the lever using the support members 19 as a support.

Meanwhile, the upper mold 20 is formed as a planar surface with a predetermined width, as shown in FIG. 6, and protruding ridges corresponding to the recesses of the lower mold 10 are formed on the planar surface. The upper mold 20 is stacked on top of the lower mold 10 to apply pressure to the upper surface of the composite fabric 1.

This upper mold 20 comprises an upper body 21 formed as a plane with a predetermined width, and a raised portion 22 with a plurality of protrusions corresponding to the recessed portion 12 of the lower mold 10 within the plane allowed by the upper body 21.

The upper body 21 is formed into a rectangular, square, or other shape with a predetermined thickness, preferably the same shape as the lower body 11, and is sufficiently wide to uniformly press the entire surface of the composite fabric 1 for the shoe upper. The upper body 21 is preferably configured such that both the upper and lower surfaces are flat, as shown in FIG. 2, so that the press device P can uniformly press the entire surface of the composite fabric 1.

The above-mentioned raised portion 22 is formed with at least one protrusion within the range allowed by the bottom surface of the upper body 21. Such raised portion 22 can be formed in positions corresponding one-to-one with the recessed portion 12 of the lower mold 10, and can be formed slightly smaller than the recessed portion 12 so that they can be closely fitted into each recess portion 12.

According to an embodiment of the present invention, the raised portion 22 is formed by a plurality of small square columns protruding to form a cluster, i.e., design. Here, the design refers to the pattern, motive, design, brand name, logo, etc. of the shoe upper, and may be arranged in an overall U shape.

In other words, the raised portion 22 may be formed as a protruding rectangular prism, and depending on the design, it may be an arrayed cluster design comprising cylinders, triangular prisms, polygonal prisms, cones, triangular cones, etc., or it may be a single-type design such as stripes, text, or a brand logo. However, it is not limited thereto.

As shown in FIG. 6, the upper mold 20 has a fixing groove 25 formed at a position corresponding to the fixing pin 15.

Due to the configuration of the fixing pin 15 and the fixing groove 25, the composite fabric 1 is securely fixed by the fixed pin 15 during the molding process, enabling the desired upper shape to be achieved without damage or distortion to the printed layer coated on the upper surface of the third fabric shown in FIG. 4, compared to the composite fabric 1 that is molded in a fixed state on the lower mold 10 without the fixed pin 15.

As shown in FIGS. 10a and 10b, it is possible to compare the molded composite fabric 1 depending on the presence or absence of fixing pins 15. FIG. 10a shows the molded upper without fixing pins 15, while FIG. 10b shows the molded upper fixed by thirteen fixing pins 15.

That is, in the case of FIG. 10a where the fixing pin 15 is not used, it is observed that a large number of defects occur because the color of the printed layer of the composite fabric 1 that has been molded through the upper and lower molds 10, 20 and the pattern dividing line do not match the actual thickness difference of the upper product. As shown in FIG. 10b, if the fixing pins 15 are used, it can be seen that the color of the printed layer of the composite fabric 1 that has been molded through the upper mold 10 and lower mold 20 and the pattern dividing line match the thickness difference of the actual upper product exactly 1:1, so that there is no problem at all in implementing a high-quality product shape. In this way, if the fixing pins 15 and the fixing groove 25 are formed in the upper and lower molds 10, 20, respectively, the printed layer of the composite fabric 1 and the actual molded thickness difference can be matched exactly 1:1, as shown in FIGS. 8 and 10b. That is, by precisely matching the ink gradient and height gradient of the printing layer one-to-one (1:1) as in FIG. 10b, the phenomenon of the ink of the printing layer flowing to another place, specifically, the problem as in FIG. 10a, i.e., the problem of the ink gradient and height gradient overlapping can be prevented.

As described above, during the forming process of the composite fabric 1, the fixing pins 15 can firmly fix the composite fabric 1, and in order to increase a fixing strength, it is preferable to form the number of fixing pins 15 and fixing grooves 25 within 5 to 20, and these can be formed at the edge and center of the composite fabric 1, respectively. It is preferable to form a plurality of fixing pins 15 and fixing grooves 25 as described above. This is because when heat is applied to the composite fabric 1 according to aspects of the present invention, that is, during the molding process, if there is no fixing pin or the number of fixing pins 15 is small, the composite fabric 1 shrinks due to the heat, and as a result, a problem occurs in which the ink gradation and the height gradation do not match one-to-one (1:1) as in FIG. 10a. in order to solve this problem, the number of fixing pins 15 and fixing grooves 25 is formed to be 5 to 20, preferably, 13 fixing pins 15 and 13 fixing grooves 25 are formed, respectively, so that the composite fabric 1 does not shrink during the molding process according to aspects of the present invention. However, the number of fixing pins and fixing grooves are not limited to thereto.

Furthermore, an aspect of the present invention may use metals such as aluminum or epoxy resin for the lower mold 10 and upper mold 20 in order to reduce manufacturing costs, achieve lightweight properties, and improve thermal conductivity during product molding. This not only reduces operator fatigue by lightening the weight of the mold but also enables precise molding of concave and convex patterns on the mold, thereby enhancing design quality. As a result, the superior thermal conductivity compared to steel allows the heat generated and cooled by the press device P to be smoothly transmitted to the composite fabric 1, thereby improving product quality and productivity of shoe uppers.

In addition, the materials of the lower mold 10 and upper mold 20 can be made of various lightweight metals, various fiber-reinforced plastics (FRP), engineering plastics, etc., depending on the type of composite fabric 1 used, as well as conditions such as molding temperature and pressure.

Next, the fabric preparation step S20 is a process for manufacturing a composite fabric 1 composed of foam and textile, which involves bonding the foam and textile together to form a foam package.

As shown in FIG. 4, the composite fabric 1 may include: a first fabric made of a textile with a thickness of 0.3 to 3.0 mm; a second fabric made of foam with a thickness of 1.0 to 10 mm, which is laminated on the upper surface of the first fabric; a third layer formed by a textile material with a thickness of 0.3 to 3.0 mm, laminated on the upper surface of the second layer; and a printed layer coated with a thickness of 0.02 to 2.0 mm on the upper surface of the third layer. The material of the foam includes not only commonly used polyurethane foam, but also various types of foamed sheets manufactured using synthetic resins or natural resins that can be effectively used for shoe uppers.

As shown in FIGS. 2-3 and 6, the mold fitting step S30 is a process of aligning the lower mold 10 and the upper mold 20 by a gap between the upper and the lower molds 10, 20 using a stopper 100 while placing the composite fiber 1 in between, and installing the aligned the lower mold and lower mold 10, 20 on a press device P.

When the lower mold 10 and upper mold 20 are interlocked, the gap between the upper mold 10 and the lower mold 20 is set, as shown in the enlarged view in FIG. 6, by inserting the stoppers 100 into the guiding pins 23 formed in the upper mold 20 as shown in the enlarged view of FIG. 6. By inserting the stoppers 10 into the guiding pin 23 formed on the upper mold 20, the gap between the upper mold 10 and the lower mold 20 is set according to the thickness of the stopper 102 thereby allowing the pressure applied to the composite fabric 1 by the upper mold 10 and the lower mold 20 to be adjusted. In particular, depending on the thickness of the product, one or more stoppers (100) may be inserted onto a single guide pin 23 to adjust the thickness of the product, i.e., the thickness of the shoe upper. The stopper, according to an aspect of the present invention, may serve to ensure a uniform thickness of the shoe upper part. Typically, as shown in FIG. 4, the composite fabric 1 has textile on the top and bottom with foam in between. However, the foam is not uniformly thick during skiving, (For example, when skiving a foam block to a thickness of 4 mm, the entire surface of the foam is not uniformly cut to exactly 4 mm thickness, but rather variations such as 4.2 mm, 4.1 mm, and 4.4 mm occur.) If molding is performed without using the stopper 100, thick variations occur on the product surface. To prevent un-uniform in thickness, the stopper 100 according to an aspect of the present invention is used to cause thicker parts of the foam to be compressed more during the molding process, while parts with uniform thickness are compressed less, thereby ensuring a consistent overall thickness in the finished product.

As described above, the thickness of the stopper 100 according to aspects of the present invention, enabling the pressure applied to the upper and lower molds 10, 20 by the press device P to be adjusted as shown in FIG. 2. This ensures that the thickness and hardness of the composite fiber 1 are uniformly formed, thereby minimizing product defects and enabling the production of shoe uppers with various thicknesses and hardnesses.

The stopper 100 can be produced with a predetermined thickness and inserted as desired, but for convenience, it is preferable to use stopper 100 of various thicknesses according to a thickness of the shoe upper to be produced. The thickness T of the stopper 100 may be formed within a range of 0.5 to 2.0 mm, considering various molding conditions according to aspect(s) of the present invention.

The reason for this is that if the thickness of the stopper 100 is less than 0.5 mm, the pressure applied to the upper and lower molds 10, 20 through the press device P is transmitted too strongly, making it difficult to match the hardness and thickness of the upper molded by the composite fiber 1. If the thickness of the stopper 100 exceeds 2.0 mm, the gap between the upper and lower molds 10, 20 becomes excessively wide, causing the pressure transmitted to the composite fabric 1 to be too low, resulting in under-molding of the manufactured upper or uneven shape stability.

Depending on thickness T, i.e., a height, of the stopper 100, a target thickness of the shoe upper formed after compression by the press device P as shown in FIG. 2 is as shown in [Table 1] below.

TABLE 1

| | Upper thickness | Recessed | Stopper | Composite fiber |
|---|---|---|---|---|
| No. | (target) | portion | Thickness | thickness |
| 1 | 3 mm | 2.5 mm | 0.5 mm | 5 mm |
| 2 | 4 mm | 3.5 mm | 0.5 mm | 6 mm |
| 3 | 5 mm | 4.0 mm | 1.0 mm | 7 mm |
| 4 | 6 mm | 4.5 mm | 1.5 mm | 8 mm |
| 5 | 7 mm | 5.5 mm | 1.5 mm | 9 mm |
| 6 | 8 mm | 6.0 mm | 2.0 mm | 10 mm |

As shown in [Table 1] above, when the thickness T of the stopper 100 is formed to be 0.5 to 2.0 mm and the depth of the recessed portion 12 corresponding to the raised portion 22 is set to 2.5 to 6.0 mm, it has been confirmed that, depending on the type of product, the target thickness of the upper can be uniformly formed within the range of approximately 3.0 to 8.0 mm by considering the depth of the recessed portion 12 and the thickness T of the stopper 100.

Additionally, mold fitting step S30 may include preparing the upper mold 20 for press forming by covering the lower mold 10 with the upper mold 20 while the prepared composite fabric 1 from the fabric preparation step S20 is spread out on the upper surface of the lower mold 10, as shown in FIG. 1. At this time, a plurality of the guide pins 23 of the upper mold 20 are inserted into corresponding a plurality of guiding grooves or buried holes 13 of the lower mold 10, respectively, and the positions of the molds are adjusted so that the recessed portion 12 of the lower mold 10 and the raised portion 22 of the upper mold 20 are accurately aligned.

For this purpose, a composite fabric 1 is placed to match the recessed portion 12 of the lower mold 10, and the composite fabric 1 is temporarily fixed by inserting it onto the protruding fixing pins 15 around the recessed portion 12; inserting a stopper 100 into the guiding pin 23 to set the gap between the upper and lower molds 10, 20, and positioning the upper mold 20 on top of the lower mold 10 so that the guiding grooves 13 formed as a recess on the edge of the lower mold 10 and the guiding pin 23 protruding from the edge of the upper mold 20 in a one-to-one correspondence on the edge of the upper mold 20 at a position corresponding to the guiding grooves 13 in a one-to-one relationship, so that the guiding pin 23 protruding from the edge of the upper mold 20 can be positioned on the same vertical line as the guiding grooves 13 formed in the recessed portion 12 on the edge of the lower mold 10; a mold stacking step S33 wherein the upper mold 20 is stacked atop the lower mold 10, aligning the recessed portion 12 of the lower mold 10 with the raised portion 22 of the upper mold 20 to induce double-sided pressing of the composite fabric 1.

Finally, the shoe upper forming step S40 is a process for forming the shoe upper onto the composite fiber 1 interposed between the lower mold 10 and the upper mold 20 by activating the press device P to apply pressure to the lower mold 10 and the upper mold 20, as shown in FIG. 2.

As shown in FIGS. 1 and 2, the shoe upper forming step S40 may include: a first pressurizing step S41 of pressing the upper while supplying heat to the molding mold M from the press device P to heat it; and a second pressurizing step S42 of pressing the upper while cooling the molding mold M by supplying coolant (5 to 10° C.) from the press device P to the upper die a and the lower die b to maintain and preserve the molding pattern according to an aspect(s) of the present invention.

As described above, the shoe upper molding step forming step S40 may further include an upper post-processing step S43 in which, after completing the first pressurizing step S41 and the second pressurizing step S42, the shoe upper molded in the mold M is removed and then silicone is applied to the molded pattern surface to enhance cushioning, texture, and touch. This may accomplish to produce shoe uppers with more vivid patterns according to an aspect(s) of the present invention.

At this time, since thickness and/or hardness of the shoe upper necessarily vary depending on the product requirements, previously, molds of various specifications had to be prepared, or the pressure or temperature of the press device had to be varied. However, the thickness T of the stopper 100 can be adjusted while the pressure of the press device is maintained constant, enabling the production of high-quality uppers under various molding conditions according to an aspect(s) of the present invention.

The method for manufacturing a shoe upper with a high-quality 3D design printed thereon using the upper and lower molds having the above-described configuration can form a pattern on the upper while imparting various colors to it by simply interposing a composite fiber between the lower mold and the upper mold and pressurizing the lower mold and the upper mold upward and downward, thereby maximizing the convenience and efficiency of work and enabling mass production of lightweight uppers of superior quality in a short period of time according to an aspect(s) of the present invention.

Furthermore, unlike the conventional method of layering multiple layers of dye ink, the present invention precisely forms intaglio and relief on the shoe upper by pressing the lower mold and shoe upper mold with interposing stoppers therebetween upward and/or downward, so that the edges of the pattern protrude sharply without becoming dull, forming an upper pattern with a maximized 3D effect. At the same time, since various colors are provided, the amount of dye ink used can be reduced, which can actively contribute to reducing production costs.

As described above, the method for manufacturing a show upper with a high-quality 3D design printed using the upper and lower molds according to an aspect of the present invention has been exemplary described based on the embodiments shown in the drawings. It is understood that the lower mold and the upper mold are merely an example for explaining an aspect of the present invention, the lower and the upper may be interchangeable with each other. It should be clearly understood that various modifications and equivalent other embodiments are possible for those skilled in the art to which the present invention pertains.

Therefore, the true technical protection scope of the present invention is defined by the matters set forth in the claims, and technical ideas within a range equivalent thereto should be construed as being included within the scope of the rights of the present invention.

[explanation of symbols]

| | |
|---|---|
| S10: mold preparation step | S20: fabric preparation step |
| S30: mold fitting step | S40: shoe upper forming step |
| 10: lower Mold | 11: lower body |
| 12: recessed portion | 13: guiding groove |
| 15: fixing pins | 18: Inner Entrance |
| 19: support | 20: upper Mold |
| 21: upper body | 22: raised portion |
| 23: guiding pin | 25: fixed groove |
| 100: stopper | 101: opening portion |

1. A method for manufacturing a shoe upper with a 3D three-dimensional design printed thereon using upper mold and lower mold, the method comprising:
a mold preparation step for preparing a lower mold and an upper mold respectively;
a fabric preparation step for preparing a composite fabric composed of foam and textile;
a mold fitting step for interposing the composite fabric between the lower mold and the upper mold, aligning the lower mold and the upper mold with a predetermined gap, and installing the aligned the upper mold and the lower mold on a press device; and
a shoe upper forming step for pressing the installed mold and the lower mold by the press device while heating, and pressing the installed upper mold and the lower mold by the press device while cooling to form a shoe upper into a predetermined shape.

2. The method of manufacturing the shoes upper of claim 1, wherein the lower mold includes:
a recessed portion having a plurality of grooves having a shape corresponding to the product's appearance and pattern formed on the lower body, and a guiding grooves formed on the lower body at a position adjacent to the corner of the lower body to match the upper mold,
wherein the upper body includes:
a raised portion having multiple protrusions corresponding to the recessed portions of the lower mold, and guiding pins protruding at positions corresponding to the guiding grooves of the lower mold and being inserted into the guiding grooves of the lower mold to align with the lower mold.

3. The method of manufacturing the shoes upper of claim 1, wherein the mold preparation step includes:
a mold adjustment step of sketching a mold outline suitable for a design of the shoe upper to be manufactured using a 3D design program;
a body forming step of preparing a lower body of the lower mold and an upper body of the upper mold by processing a mold material;
a computer numerical control (CNC) work step of forming a recessed portion on the surface of the lower mold and a raised portion on the surface of the upper body using a CNC machine; and
a mold post-processing step of cleaning, post-processing, and heat-treating the CNC-processed lower mold and upper mold.

4. The method of manufacturing the shoes upper of claim 1, wherein the composite fabric of the fabric preparation step comprises:
a first fabric made of a textile having a thickness of 0.3 to 3.0 mm;
a second fabric made of a foam having a thickness of 1.0 to 10 mm, layered on an upper surface of the first fabric;
a third fabric made of a textile having a thickness of 0.3 to 3.0 mm, layered on an upper surface of the second fabric; and
a printing layer having a thickness of 0.02 to 2.0 mm and coating with a dyeing agent on the upper surface of the third fabric.

5. The method of manufacturing the shoes upper of claim 1, wherein the mold fitting step comprises inserting at least one or more stoppers into a plurality of guiding pins formed on the upper mold, respectively, thereby setting a predetermined gap between the upper mold and the lower mold based upon a thickness of the stopper.

6. The method of manufacturing the shoes upper of claim 1, wherein the mold fitting step includes:
a fabric fixing step of placing a composite fabric in alignment with the recessed portion of the lower mold and fixing the composite fabric by inserting the composite fabric into a plurality of fixing pins protruding around the raised portion;
a mold placement step of inserting a stopper into a guiding pin to set a predetermined gap between the upper mold and the lower mold, and aligning the upper mold on the lower mold so that the guiding grooves formed recessed in an edge of the lower mold and the guiding pins formed protruding at a position corresponding one-to-one (1:1) to the guiding grooves at an edge of the upper mold are positioned on the same vertical line;
a mold stacking step in which an upper mold is stacked on top of a lower mold, and the recessed portion of the lower mold and the raised portion of the upper mold are aligned to induce double-sided pressure on the composite fabric.

7. The method of manufacturing the shoes upper of claim 1, wherein the shoe upper molding step comprises:
a first press step of heating and pressing the shoe upper by supplying heat from a press device to a molding mold comprising the lower mold and the upper mold; and
a second press step of cooling the molding mold by supplying coolant from the press device to the upper die and the lower die to pressurize the upper and maintain the molding pattern.

8. The method of manufacturing the shoes upper of claim 1, wherein the lower mold and the upper mold are in a shape of rectangular and the plurality of guiding pins are located adjacent to each corner of the upper mold.

9. The method of manufacturing the shoes upper of claim 1, wherein the lower mold and the upper mold are in a shape of rectangular and the plurality of guiding pins are located adjacent to the each corner of the upper mold.

10. The method of manufacturing the shoes upper of claim 2, wherein the guiding grooves are in a shape of through hole.

11. A method for manufacturing a shoe upper with a 3D three-dimensional design printed thereon using upper mold and lower mold, the method comprising:
preparing an upper mold and a lower mold;
attaching a composite fabric on the lower mold;
aligning the upper mold with the lower mold with the composite fabric attached on the lower mold with a predetermined gap between the lower mold and the upper mold;
putting the aligned the lower mold and upper mold on a press device; and
pressing the lower mold and upper mold with the press machine, to mold the composite fabric attached on the lower mold into a predetermined shape, while sequentially heating and cooling.

12. The method of manufacturing the shoes upper of claim 11, wherein the maintaining the predetermined gap between the upper mold is the lower mold is performed by putting at least one or more stoppers into a plurality of guiding pins formed on the upper mold, respectively,
aligning the upper mold with the lower mold by inserting the guiding pins formed on the upper mold into the guiding grooves formed on the lower mold.

13. The method of manufacturing the shoes upper of claim 11, wherein
the guiding groove formed on the lower mold at a position adjacent to each corner of the lower mold to match the upper mold.

14. The method of manufacturing the shoes upper of claim 11, further comprising setting the predetermined gap between the upper mold and the lower mold is adjusted based upon number of stoppers putting into a plurality of guiding pins formed on the upper mold.

15. The method of manufacturing the shoes upper of claim 11, wherein the attaching the composite fabric on the lower mold is by a plurality of fixing pins.

16. A method for manufacturing a shoe upper with a 3D three-dimensional design printed thereon using upper mold and lower mold, the method comprising:
preparing an upper mold with stoppers attached and a lower mold;
attaching a composite fabric on the lower mold;
aligning the upper mold with stoppers attached and the lower mold with the composite fabric attached on the lower mold with a predetermined gap between the lower mold and the upper mold;
putting the aligned the lower mold and upper mold on a press device; and
pressing the lower mold and upper mold with the press machine, to mold the composite fabric attached on the lower mold into a predetermined shape, while sequentially heating and cooling.

17. The method of manufacturing the shoes upper of claim 16, wherein the attaching the composite fabric on the lower mold is by a plurality of fixing pins.
